(19) United States
(12) Patent Application Publication
(10) Pub. No.: US 2012/0298697 A1
(43) Pub. Date: Nov. 29, 2012

(54) Venting Apparatus Used for a Grease Gun

(75) Inventor: Wen-I Guo, Taichung City (TW)

(73) Assignee: SUCTION INDUSTRIAL CO., LTD., Taichung City (TW)

(21) Appl. No.: 13/118,083

(22) Filed: May 27, 2011

(51) Int. Cl. G01F 11/00

(52) U.S. Cl. 222/256; 222/387

(57) ABSTRACT

A grease control structure of a grease gun comprises a main body including an inlet end and an outlet end. A high-pressure flow passage and a low-pressure flow passage having a larger outer diameter than the high-pressure flow passage are disposed between the inlet and outlet ends. The high-pressure flow passage includes a first inlet and a second inlet, and both passages include a first pump rod and a second pump rod respectively. The first pump rod is pivotally connected to a pressing handle and the second pump rod is pivotally connected to a pressing handle through a switch mechanism used for adjusting the pivotal position of the second pump and pressing handle to change their original position in the low-pressure flow passage for the second pump rod to precede the piston movement to close or open the second inlet and define a high- or low-pressure outlet pressure.

### BACKGROUND OF THE INVENTION

1. Field of the Invention

The present invention relates to a venting apparatus, particularly to a grease gun which can vent a mixture of air and grease from the grease gun.

2. Description of the Related Art

The operating principle of a grease gun is to move a pump rod in a flow passage of the gun back and forth so that the grease in the flow passage can be pushed out continuously. When the pump rod moves forwards, the grease in the flow passage is pushed out of a muzzle. And then the non-return valve close to the muzzle seals the muzzle, so that the air pressure in the flow passage decreases when the pump rod moves backwards. The internal space in the grease tank disposed in the grease gun forms a relative high pressure. The pressure difference causes the grease in the grease tank enter the flow passage. Therefore, the grease can be pushed out when the pump rod moves forwards again. The grease can be supplied continuously in cycles.

But, when using the grease gun, an empty grease tank is filled with grease to be reused. In the refilling process, it is inevitable to mix air and grease together. Because of different properties of various kinds of fluids, the grease cannot be compressed but the air can.

Therefore, in the reciprocating process of the pump rod, the grease is gradually pushed out, but the air gradually accumulates and stays in the flow passage. Therefore, the pressure drop is getting smaller so as to cause a too-small pressure difference between the flow passage and the grease tank. The grease in the grease tank cannot enter the flow passage, and then the pump rod keeps pushing the air in the flow passage to form an idle state and thus the grease cannot be pushed out.

The conventional grease gun includes a venting apparatus with the similar design as described above, but the venting apparatus is disposed in the grease tank, or on a side of the grease gun body. Air cannot be emitted from the venting apparatus unless the air accumulates around the position of the venting apparatus. And the conventional grease gun does not come with a design to guide the air flow to a position proximate to the venting apparatus. In other words, whether or not the venting design of the grease gun can work depends on luck. Obviously, such venting apparatus is not practical in use.

### SUMMARY OF THE INVENTION

The purpose of the present invention is to provide a venting apparatus used for a grease gun. The venting apparatus can emit the air in the flow passage of the grease gun to keep the grease gun working.

To achieve the purpose mentioned above, the present invention provides a venting apparatus used for a grease gun, comprising:
a main body, comprising a front end, a back end connected to an outlet end of the grease gun, and a flow passage penetrating from the front end to the back end, and the flow passage comprising a front section and a back section, wherein an outer diameter of the front section is larger than an outer diameter of the back section, and the front section of the flow passage comprising a normally closed valve to seal an outlet of the back section connected to the outlet of the front section in the flow passage, and a lateral border of the main body comprising a venting hole connected to the back section of the flow passage; and
a venting valve, disposed in the opening, and closed normally and controlled to be open, and the back section of the flow passage being connected to an external environment through the venting valve when the venting valve is open.

### BRIEF DESCRIPTION OF THE DRAWINGS

FIG. 1 is a section view of the first embodiment of the present invention;

FIG. 2 is a schematic view of a first application of the first embodiment of the present invention;

FIG. 3 is a second schematic view of a first application of the first embodiment of the present invention;

FIG. 4 is a third schematic view of a first application of the first embodiment of the present invention;

FIG. 5 is a fourth schematic view of a first application of the first embodiment of the present invention;

FIG. 6 is a fifth schematic view of a first application of the first embodiment of the present invention;

FIG. 7 is a sixth schematic view of a first application of the first embodiment of the present invention;

FIG. 8 is a schematic view of a second application of the first embodiment of the present invention; and

FIG. 9 is a section view of an application of the second embodiment of the present invention.

### DETAILED DESCRIPTION OF THE PREFERRED EMBODIMENTS

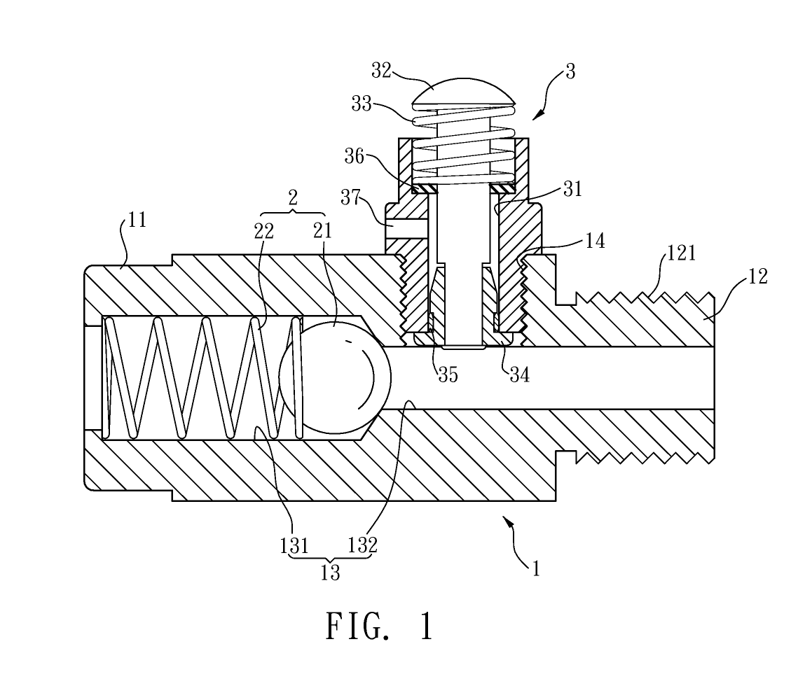

With reference to FIG. 1 for a venting apparatus used for a grease gun in accordance with the first embodiment of the present invention, the venting apparatus comprises a main body 1, including a front end 11 and a back end 12. The lateral peripheral of the back end 12 includes a screw thread 121, and the back end 121 is screwed and connected to an outlet end of the grease gun. The front end 11 can be connected to an extension pipe for convenience in use. The internal space of the main body 1 includes a flow passage 13 penetrating from the front end 11 to the back end 12, and the flow passage 13 includes a front section 131 and a back section 132. The outer diameter of the front section 131 is larger than the outer diameter of the back section 132. A normally closed valve 2 is disposed at the front section 131 of the flow passage 13 to normally seam the interface of the back section 132 and front section 131 of the flow passage 13. There is a steel ball 21 with an outer diameter larger than the outer diameter of the back section 132 of the flow passage 13 and a spring 22 in the normally closed valve 2, and they are disposed in the flow passage in order in the front section 131 of the flow passage 13. The steel ball 21 normally seals the interface of the back section 132 and the front section 131 of the flow passage 13 by the elastic force of the spring 22.

There is a venting hole 14 connected to the back section 132 of the flow passage 13 in the main body 1. There is a venting valve 3 disposed in the venting hole 14. The venting valve 3 is normally closed but can be controlled to be open. The venting valve 3 includes a channel 31 connected to the back section 132 of the flow passage 13, and there are a pressing device 32 and a spring 33 disposed in the channel 31. The pressing device 32 has a flange formed at the top of the pressing device 32 and a stop block 34 formed at the bottom of the pressing device 32 for sealing the channel 31, and the stop block includes an anti-leaking ring 35 installed around the periphery of the stop block 34 and a fastener 36 installed around the periphery of the pressing device 32 for sealing the channel 31, and the channel 31 has a ventilation hole 37 formed under the fastener 36 and interconnected to the outside, and the spring 33 is sheathed onto the periphery of the pressing device 32 and both ends of the spring 33 abut the flange of the pressing device 32 and the fastener 36 respectively. The spring 33 covers the outer of the pressing device 32 and is positioned in the channel 31. There is a stop block 34 disposed at the end of the pressing device 32 for sealing the channel 31. There is an anti-leaking ring 35 disposed in the peripheral of the stop block 34. The stop block 34 normally seals the channel 31 by the elastic force of the spring 33. When the pressing device 32 is pressed, the stop block 34 is pushed to move downwards by the pressing device 32, such that the back section 132 of the flow passage 13 is interconnected to the outside through the channel 31 and the ventilation hole 37.

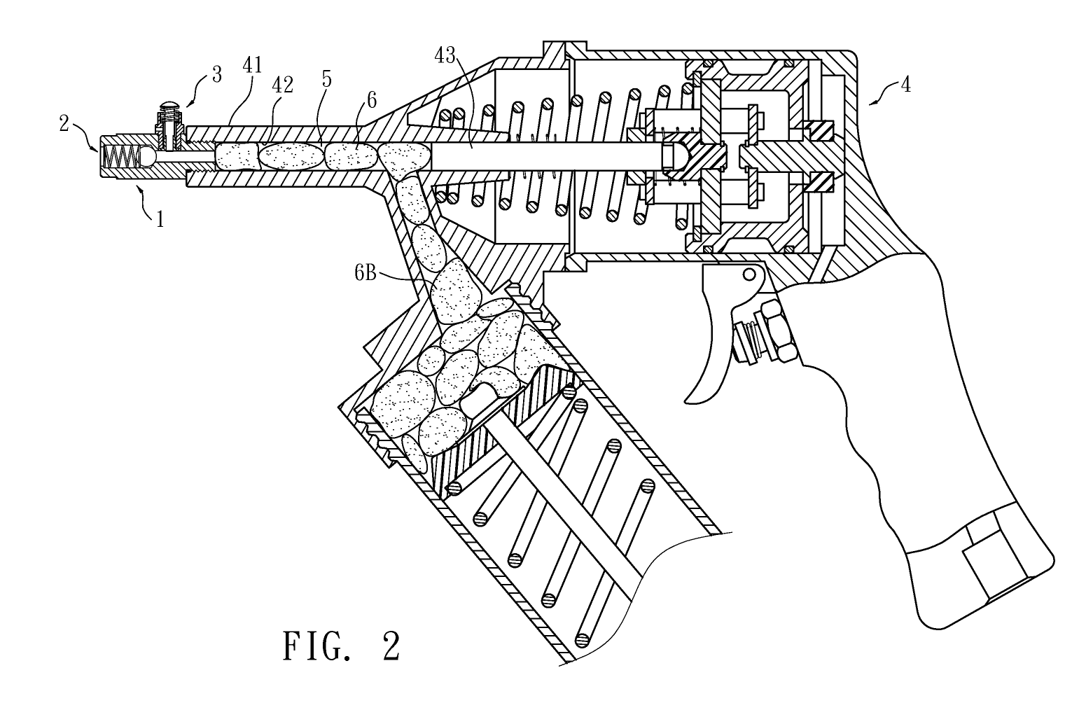

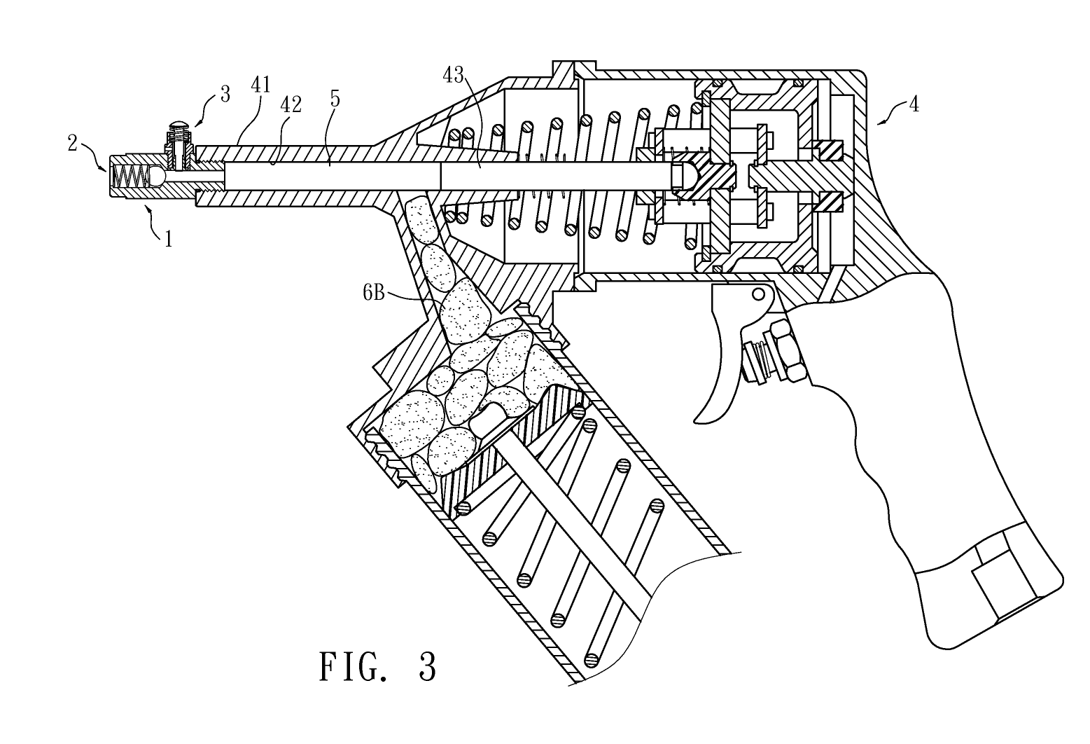

Referring to FIG. 2, the first operating embodiment of the present invention comprises the components mentioned above, and the back section 12 of the embodiment is screwed to connect the outlet 41 of an air-driven grease gun 4. At the beginning phase in use, the flow passage 42 of the grease gun 4 is full of the grease 6 mixed with air 5. After a period of time of use, because of the difference of the compressibility of the grease 6B and air 5 (the grease is not compressible but the air is.), when the pump rod 43 of the grease gun 4 is driven by the high pressure air to move back and forth, the un-compressible grease 6 is gradually pushed out, but the compressible air accumulates and stays in the flow passage 42 due to the changeable volume, like the situation as shown in FIG. 3. When the air 5 in the flow passage 42 is too much, there is no sufficient pressure drop formed in the flow passage 42 even though the pump rod 43 moves backwards so that the grease 6B in the grease tank of the grease gun 4 cannot enter the flow passage to be used.

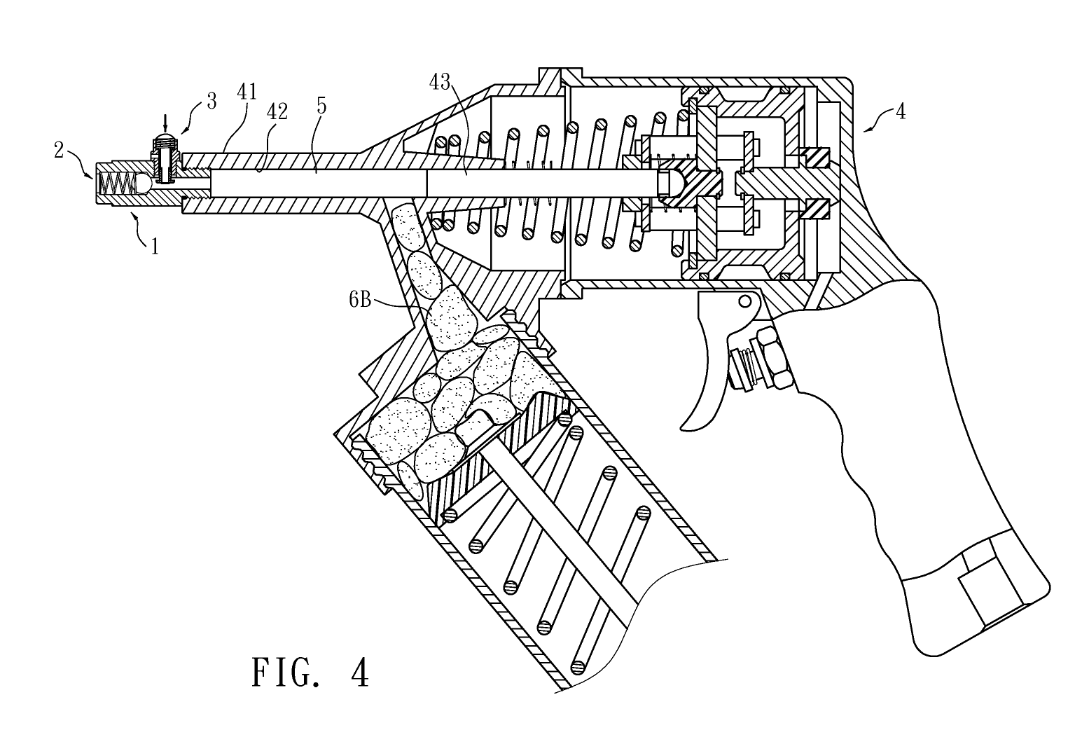

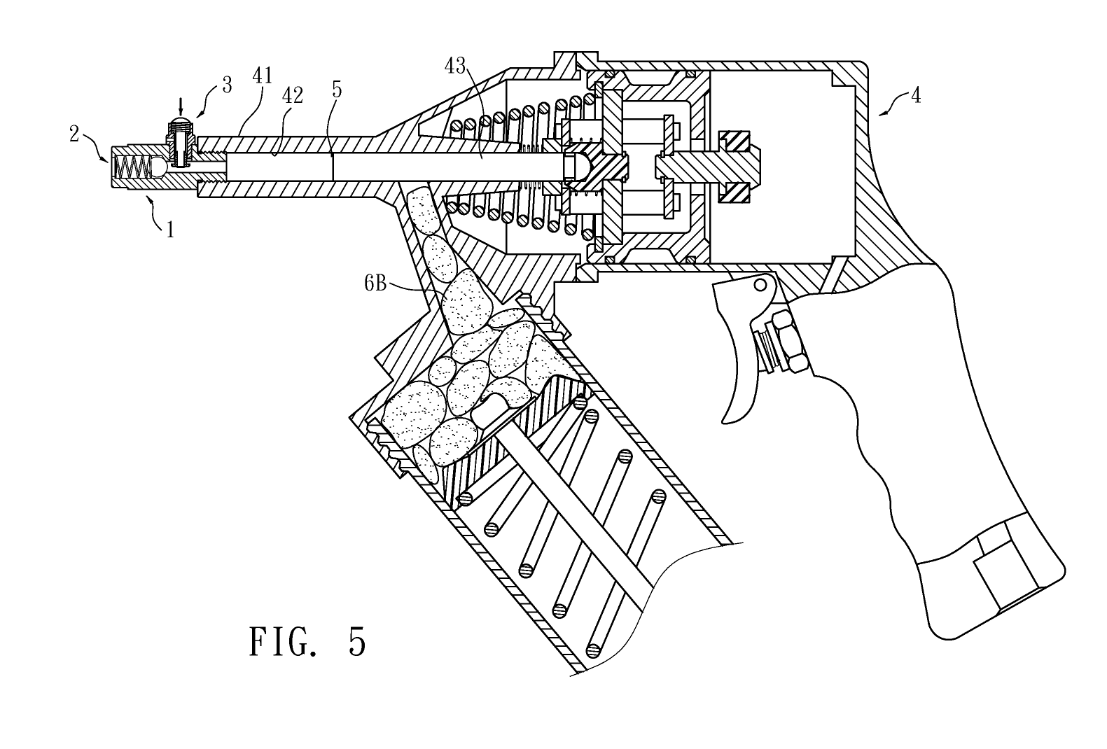

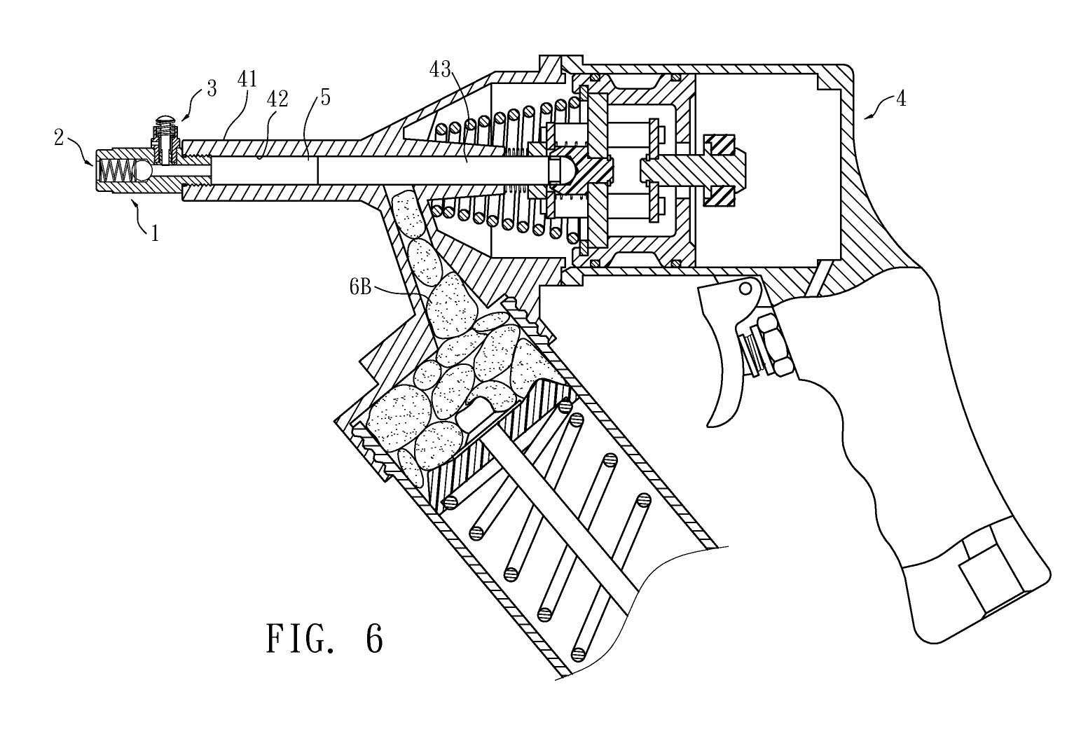

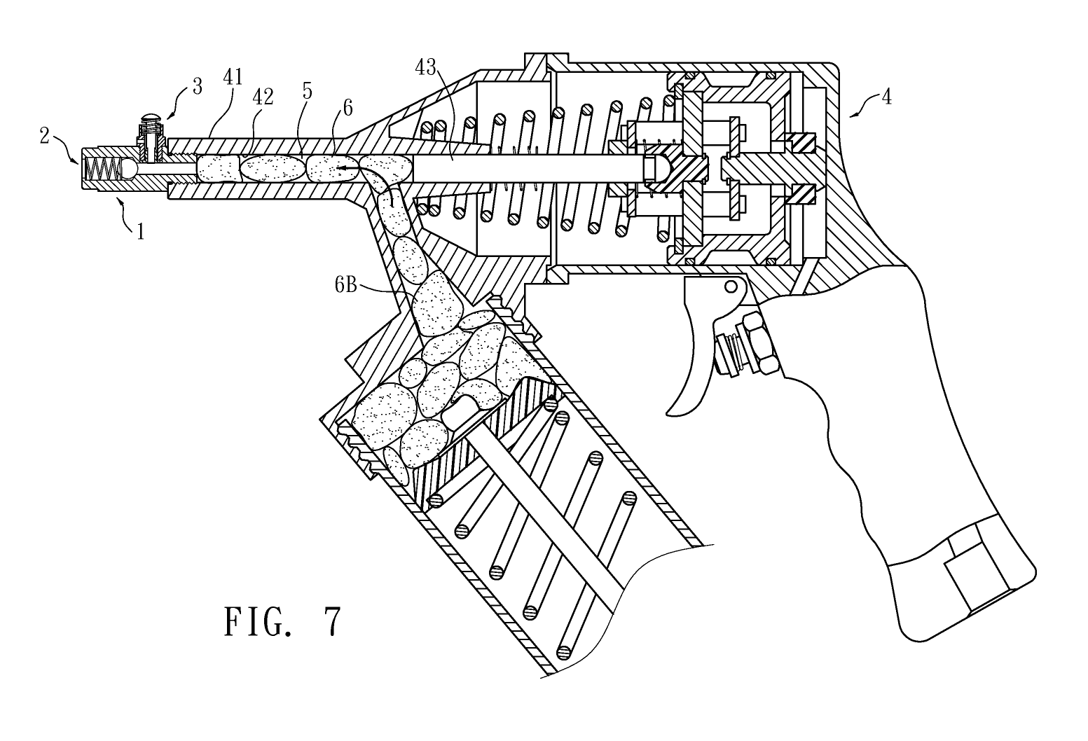

At this moment, referring to FIG. 4, the pressing device 32 of the venting valve 3 is pressed to drive the stop block 34 to seal the channel 31 of the venting valve 3 to move downwards, so that the channel 31 can be passed through and the flow passage 42 can be connected to the external environment through the venting valve 3. And the pump rod 43 is driven by the high-pressure air to move back and forth several times per second. Because the pump rod reciprocates so fast, the probability for the pump rod to be pushed to the end position (as shown in FIG. 5) is about 50%. When the pump rod 43 moves forwards, the air 5 in the flow passage 42 is pushed out through the venting valve 3. As shown in FIG. 6, when the pressing device 32 is not pressed, the pressing device 32 drives the stop block 34 by driving the spring 33 to return to its original position so as to seal the channel 31 of the venting valve 3. The flow passage 42 of the grease gun 4 defines a sealed space, so that, as shown in FIG. 7, a sufficient pressure drop can be formed in the flow passage 42 when the pump rod 43 moves backwards again. The grease 6B in the grease tank can enter into the flow passage 42 by the pressure difference, and the grease gun 4 can be reused.

According to the above explanation, through the ways that the venting apparatus of the present invention is disposed at the outlet end 41 of the air-driven grease gun 4, the air in the flow passage 42 is pushed out through the venting valve 3 by moving the pump rod 43 when the venting valve 3 is open, and then a sealed space is formed in the flow passage 42 by closing the venting valve 3 before the pump rod 43 moves backwards, the sufficient pressure drop can be formed in the flow passage 42 to drive the grease gun 4 to work. Although the venting valve 3 is not always closed before the pump rod 43 moves backwards (with a probability of about 50%), the present invention allow users to control the venting valve 3 so that there is 50% probability to emit the air 5 in the flow passage 42 of the grease gun compared with the conventional venting apparatus whose position affecting whether or not the venting apparatus can work depends on the position of the accumulation of the air. The venting function has had progressed a lot.

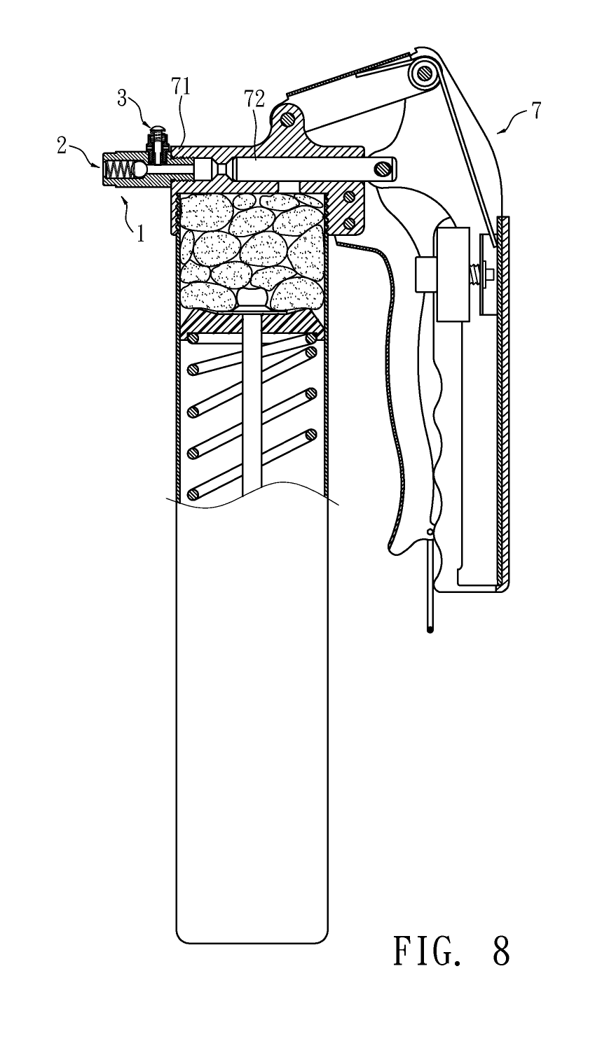

With reference to FIG. 8 for the second application of the first embodiment of the present invention, the present invention is disposed in the outlet end 71 of a manual grease gun 7. The operation is like the first application, but in this application, users can directly control the movement of the pump rod 72. Therefore, the users can close the venting valve 3 and then manually move the pump rod 72 backwards so that the grease gun 7 can work normally. In the other words, the probability of success is 100%.

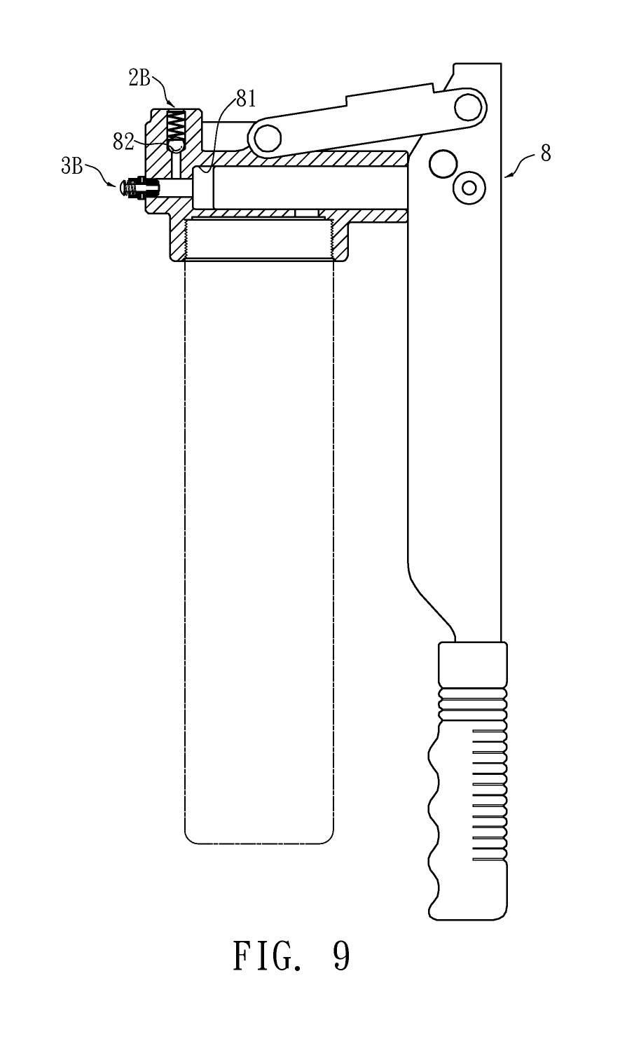

With reference to FIG. 9 for the second embodiment of the present invention, the difference between this preferred embodiment and the first embodiment resides on that this embodiment comprises two components, respectively: a normally closed valve 2B and a venting valve 3B. The two components are directly disposed in flow passage 81 of the grease gun 8 for facilitating the flow of the grease. The venting valve 3B is normally closed but can be controlled to be open. When the venting valve is open, the flow passage 81 of the grease gun 8 can be connected to the external environment through the venting valve 3B. The normally closed valve 2B is disposed at the outlet end of the flow passage 81. The normally closed valve 2B is closed normally to seal the outlet 82 of the flow passage 81. Through the configuration mentioned above and the application of the aforementioned principle, the purpose for emitting the air in the flow passage 81 of the grease gun 8 can be achieved.

What is claimed is:

1. A venting apparatus used for a grease gun, comprising:
a main body, comprising a front end, a back end connected to an outlet end of the grease gun, and a flow passage penetrating from the front end to the back end, and the flow passage comprising a front section and a back section, wherein the outer diameter of the front section is larger than the outer diameter of the back section, and the front section of the flow passage comprising a normally closed valve to seal an outlet of the back section connected to the outlet of the front section in the flow passage, and a lateral border of the main body comprising a venting hole connected to the back section of the flow passage; and
a venting valve, disposed in the opening, and closed normally and selectively controlled to be open, and the back section of the flow passage being connected to an external environment through the venting valve when the venting valve is open.

2. The venting apparatus according to claim 1, wherein the normally closed valve comprises a stop device with a diameter larger than the back section of the flow passage and an elastic device disposed in order at the front section of the flow passage so that the stop device normally seals an interface of the back section and the front section of the flow passage by an elastic force of the elastic device.

3. The venting apparatus according to claim 1, wherein the venting valve comprises a channel for connecting the back section of the flow passage and the external environment, and the channel comprises a pressing device and an elastic device, wherein an end of the pressing device comprises a stop block for sealing the channel and is driven by the elastic device to normally seal the channel, and the stop block is driven by the pressing device to cause the channel and the back section of the flow passage to be passed through when the pressing device is pressed.

4. The venting apparatus according to claim 3, wherein the stop block comprises an anti-leaking ring over the outer peripheral.

5. The venting apparatus according to claim 3, further comprising a fastener installed around the periphery of the pressing device for sealing the channel, and the elastic device being installed above the fastener, and the channel having a ventilation hole formed under the fastener and interconnected to the outside, such that when the pressing device is pressed to connect the channel and the back section of the flow passage, the back section of the flow passage is interconnected to the outside through the channel and the ventilation hole.

6. The venting apparatus according to claim 1, wherein the front end of the main body can be connected to an extension pipe.

7. A venting apparatus used for a grease gun, comprising:
a venting valve and a normally closed valve disposed in a flow passage of the grease gun in order, wherein the venting valve is disposed in the grease gun and connected to the flow passage, and the venting valve is normally closed and selectively controlled to be open, and the flow passage of grease gun is connected to the external environment when the venting valve is open; and
the normally closed valve, disposed in an outlet end of the flow passage, and normally closed to seal an outlet of the flow passage.

8. The venting apparatus according to claim 7, wherein the normally closed valve comprises a stop device with an outer diameter larger than the flow passage of the grease gun and an elastic device, disposed in order at an outlet end of the flow passage so that the stop device normally seals an outlet of the flow passage by an elastic force of the elastic device.

9. The venting apparatus according to claim 7, wherein the venting valve comprises a channel connecting the flow passage of the grease gun and the external environment, and a pressing device and an elastic device are disposed in the channel, wherein an end of the pressing device comprises a stop block for sealing the channel and is driven by the elastic device to normally seal the channel, and the stop block is driven by the pressing device to cause the channel and the flow passage to be passed through when the pressing device is pressed.

10. The venting apparatus according to claim 9, wherein the stop block comprises an anti-leaking ring over the outer peripheral.
